(19) United States
(12) Patent Application Publication
(10) Pub. No.: US 2025/0306813 A1
(43) Pub. Date: Oct. 2, 2025

(54) IMAGE PROCESSING METHOD, IMAGE PROCESSING DEVICE, PRINTING SYSTEM, AND IMAGE PROCESSING PROGRAM

(71) Applicant: SEIKO EPSON CORPORATION, Tokyo (JP)

(72) Inventors: Yuko YAMAMOTO, SHIOJIRI-SHI (JP); Takuya ONO, SHIOJIRI-SHI (JP); Takahiro KAMADA, MATSUMOTO-SHI (JP); Mitsuhiro YAMASHITA, MATSUMOTO-SHI (JP)

(21) Appl. No.: 19/091,260

(22) Filed: Mar. 26, 2025

(30) Foreign Application Priority Data
Mar. 28, 2024 (JP) 2024-053752

(51) Int. Cl. G06F 3/12; B41J 2/21; B41J 3/46

(52) U.S. Cl. CPC G06F 3/1208; B41J 2/2114; B41J 3/46; G06F 3/1256

(57) ABSTRACT

The image processing method includes a step (a) of displaying on a display device a preview image of printed matter that reproduces a degree of a quality represented by a specified value that was set, a step (b) of, when a change instruction to change the degree of the quality is received, executing step (a) by using the specified value based on the change instruction, a step (c) of generating a print data that includes color ink information that is defined for printing a target image and that represents, in a predetermined fixed region, at least one of the size of dots of color ink to be recorded, the number of records of the dots, and an arrangement of the dots, and clear ink information that is defined based on the specified value and that represents, in a predetermined fixed region, at least one of the size of dots of clear ink to be recorded, the number of records of the dots, and an arrangement of the dots.

The present application is based on, and claims priority from JP Application Serial Number 2024-053752, filed Mar. 28, 2024, the disclosure of which is hereby incorporated by reference herein in its entirety.

### BACKGROUND

### 1. Technical Field

The present disclosure relates to an image processing method, an image processing device, a printing system, and an image processing program.

### 2. Related Art

JP-A-2004-74540 describes a technique relating to an image printing device that receives a designation of an image to be printed and a quality, and outputs a print control signal that represent the image to be printed with the designated quality to a printer.

In the technique described in JP-A-2004-74540, the finish of the printed matter cannot be confirmed in advance before printing.

### SUMMARY

The present disclosure can be implemented as the following aspects.

According to a first aspect of the present disclosure, an image processing method is provided. This image processing method includes a step (a) of displaying on a display device a preview image of printed matter that reproduces a degree of a quality represented by a specified value that was set; a step (b) of, when a change instruction to change the degree of the quality is received, executing step (a) by using the specified value based on the change instruction; a step (c) of generating print data for reproducing the quality of the printed matter represented by the preview image, the print data including color ink information that is defined for printing a target image and that represents, in a predetermined fixed region, at least one of the size of dots, the number of the dots, and an arrangement of dots to be recorded with color ink and clear ink information that is defined based on the specified value and that represents, in a predetermined fixed region, at least one of the size of dots, the number of the dots, and an arrangement of the dots to be recorded with clear ink; and a step (d) of printing the target image on a print medium with the color ink and then printing on the print medium on which the target image is printed with the clear ink based on the clear ink information.

According to a second aspect of the present disclosure, an image processing device is provided. This image processing device includes a preview image display section for displaying on a display device a preview image of printed matter in which degree of the quality represented by the specified value is reproduced; a quality setting section configured to receive a change instruction to change the degree of the quality; and a print process section that generates print data to be output to a printing device. When the change instruction to change the degree of the quality is received, the preview image display section displays the preview image on the display device using the specified value based on the change instruction. When a print start instruction is received, the print process section generates print data for reproducing the quality of the printed matter represented by the preview image, the print data including color ink information that is defined for printing a target image and that represents, in a predetermined fixed region, at least one of the size of dots, the number of the dots, and an arrangement of dots to be recorded with color ink and clear ink information that is defined based on the specified value and that represents, in a predetermined fixed region, at least one of the size of dots, the number of the dots, and an arrangement of the dots to be recorded with clear ink.

According to a third aspect of the present disclosure, a printing system is provided. This printing system includes an image processing device, a printing device, and a display device. The image processing device has a preview image display section that displays a preview image of printed matter that reproduces degree of a quality represented by a specified value that is set on the display device, a quality setting section configured to receive a change instruction to change the degree of the quality; and a print process section that generates print data to be output to the printing device. When the change instruction to change the degree of the quality is received, the preview image display section displays the preview image on the display device using the specified value based on the change instruction. When a print start instruction is received, the print process section generates print data for reproducing the quality of the printed matter represented by the preview image, the print data including color ink information that is defined for printing a target image and that represents, in a predetermined fixed region, at least one of the size of dots, the number of the dots, and an arrangement of dots to be recorded with color ink and clear ink information that is defined based on the specified value and that represents, in a predetermined fixed region, at least one of the size of dots, the number of the dots, and an arrangement of the dots to be recorded with clear ink. The printing device executes printing based on the print data.

According to a fourth aspect of the present disclosure, a non-transitory computer readable medium storing an image processing program is provided. This image processing program makes a computer execute a function (a) of displaying a preview image of printed matter that reproduces degree of a quality represented by a specified value that is set on a display device; a function (b) of, when a change instruction that changes the degree of the quality is received, executing the function (a) using the specified value based on the change instruction; a function (c) of generating print data for reproducing the quality of the printed matter represented by the preview image, the print data including color ink information that is defined for printing a target image and that represents, in a predetermined fixed region, at least one of the size of dots, the number of the dots, and an arrangement of dots to be recorded with color ink and clear ink information that is defined based on the specified value and that represents, in a predetermined fixed region, at least one of the size of dots, the number of the dots, and an arrangement of the dots to be recorded with clear ink, and a function (d) of printing the target image on a print medium with color ink, and then printing on the print medium on which the target image is printed with clear ink based on the clear ink information.

### BRIEF DESCRIPTION OF THE DRAWINGS

FIG. 1 is a block diagram showing a schematic configuration of a printing system according to the present embodiment.

FIG. 2 is a block diagram showing a schematic configuration of an example of a printing device.

FIG. 3 is an explanatory diagram schematically showing a state of observing a surface of printed matter expressed as a 3-D object in a virtual space.

FIG. 4 is an explanatory diagram showing the configuration of an image processing device.

FIG. 5 is an explanatory diagram showing an example of a user interface for specifying printing condition.

FIG. 6 is an explanatory diagram showing the processing contents of CMS.

FIG. 7 is an explanatory diagram showing a flowchart of a color conversion process.

FIG. 8 is an explanatory view showing a state in which a preview image is displayed in a display region of the user interface.

FIG. 9 is an explanatory diagram showing a state in which the display of the preview image is updated in the user interface after the user has changed the setting to the gloss side.

FIG. 10 is an explanatory diagram showing a state in which a display of the preview image is updated in the user interface after the setting is changed to the matte side.

FIG. 11 is an explanatory diagram showing a configuration of a rendering section.

FIG. 12 is a flowchart showing a process before the execution of printing that is executed in the image processing device.

FIG. 13 is a flowchart of a process for displaying a preview image in step S30 in

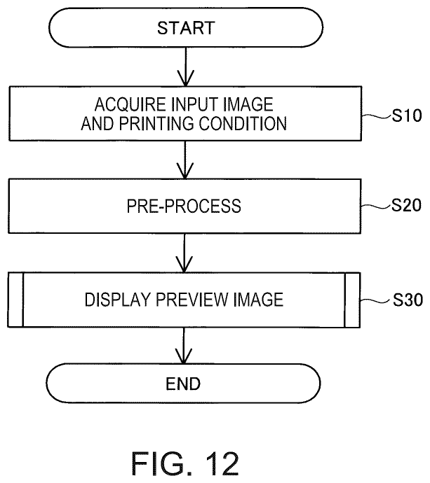

FIG. 12.

FIG. 14 is an explanatory diagram showing a quality parameter conversion table.

FIG. 15 is a flowchart of a process for generating print data.

FIG. 16 is an explanatory diagram showing a clear ink printing conversion table.

FIG. 17 is an explanatory diagram of the user interface according to another embodiment 1.

FIG. 18 is an explanatory diagram showing an example of the user interface according to another embodiment 2.

FIG. 19 is an explanatory diagram showing an example of a mask used in halftone processing to realize the gloss texture.

FIG. 20 is an explanatory diagram showing a quality parameter conversion table.

### DESCRIPTION OF EMBODIMENTS

### A. Embodiments

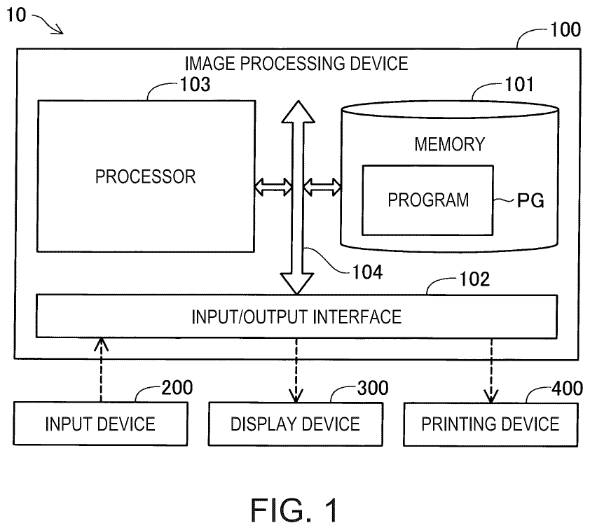

FIG. 1 is a block diagram showing a schematic configuration of a printing system 10 according to the present embodiment. The printing system 10 is equipped with an image processing device 100, an input device 200, a display device 300, and at least one printing device 400. The printing system 10 functions as a printing device in a broad sense.

The printing device 400 is an inkjet printing device that directly prints an image on a print medium. The printing device 400 can perform printing using special color ink in addition to printing using CMYKLcLm ink. In this specification, the CMYKLcLm ink is referred to as process ink for convenience. The process ink is also referred to as “color ink.” C is cyan, M is magenta, Y is yellow, K is black, Lc is light cyan, and Lm is light magenta process inks. The special color is a color other than CMYKLcLm. In the present embodiment, clear ink is used as the special color ink. The clear ink is a colorless and transparent ink applied on the surface of a color image. In the present embodiment, the clear ink is used to adjust a quality of the color image. Hereinafter, a printed layer formed by printing the process ink is referred to as a color layer. A printed layer formed by the printing of the clear ink is referred to as a clear layer.

In the present embodiment, the printing device 400 ejects ultraviolet curable type ink (UV ink) that is cured when irradiated with ultraviolet (UV) light. First, in the printing device 400, an image is formed on a print medium by ejecting the ultraviolet curable type process ink, and then a clear layer is formed on the image by ejecting ultraviolet curable type clear ink. By adjusting the ejection amount of the clear ink, the ejection method, the irradiation time of the ultraviolet light, the timing of the irradiation of the ultraviolet light, and the like, it is possible to give the clear layer a fine uneven surface or to make the surface of the clear layer uniform. By making the surface of the clear layer uniform, the gloss can be enhanced. As a result, a desired quality is imparted to the printed matter.

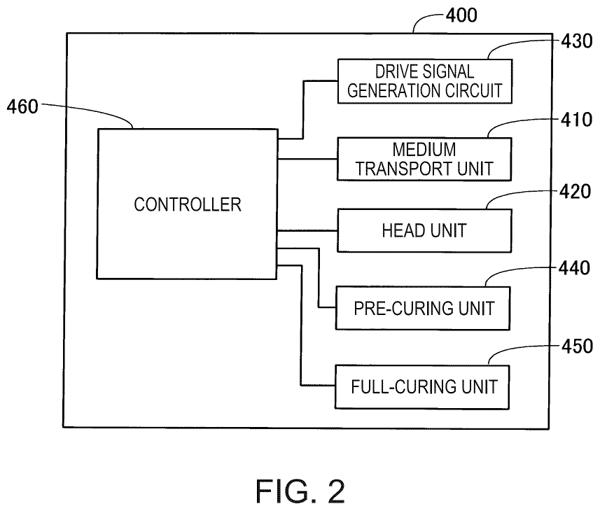

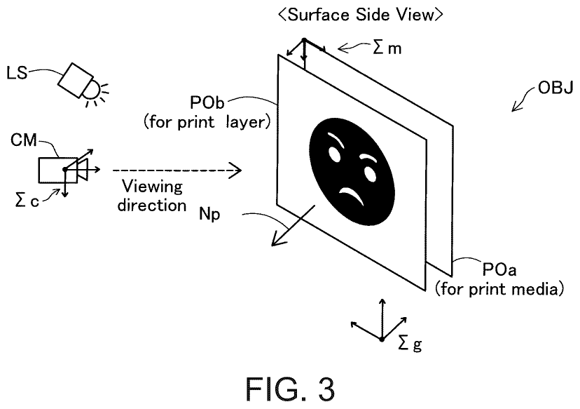

FIG. 2 is a block diagram showing a schematic configuration of the printing device 400. The printing device 400 is equipped with a medium transport unit 410 having a function of transporting a print medium, a head unit 420, a drive signal generation circuit 430, a pre-curing unit 440, a full-curing unit 450, and a controller 460.

The head unit 420 has a head unit corresponding to each color of CMYKLcLm. The head unit 420 also has a head unit for clear ink. In each head unit, a large number of nozzles are arranged at a predetermined nozzle pitch. Each head unit ejects ink to print an image on the print medium.

In the present embodiment, an example of the printing device 400 performing surface printing is explained. The term “surface printing” means printing on a front surface of the print medium.

The drive signal generation circuit 430 generates a drive signal for driving a piezoelectric element, which is a drive element included in the head unit 420. By driving the piezoelectric element, ink droplets are ejected from the nozzles of each head unit.

The pre-curing unit 440 cures the ink ejected onto the print medium by irradiating ultraviolet light. The irradiation intensity of the ultraviolet light irradiated by the pre-curing unit 440 is set to an intensity sufficient to cure the surface of the ink droplets. Curing the surface of the ink droplets is called provisional curing. As a light source of the pre-curing unit 440, for example, a UV LED is used. When the finish of the printed matter is to be a matte finish, it is desirable that the surface of the printed layer formed by the clear ink has an uneven surface. To achieve this, the clear ink is applied by adjusting the dot size and the ejection amount so that the ink droplets of the applied clear ink do not come into contact with each other, and then the ink droplets are temporarily cured by irradiating ultraviolet light using the pre-curing unit 440. By this, the ink droplets do not spread, and an uneven the surface of the printed layer formed by the clear ink is maintained. Matte finish refers to a finish with low gloss.

The full-curing unit 450 cures the ink ejected onto the print medium by irradiating ultraviolet light. Irradiation intensity of the ultraviolet light irradiated by the full-curing unit 450 is set to an intensity that completely cures the ink ejected onto the print medium. The complete curing of the ink is called “main curing.” As a light source of the full-curing unit 450, for example, a metal halide lamp is used. If the finish of the printed matter is to be a gloss finish, it is desirable that the surface of the printed layer formed by the clear ink is a smooth surface. In this case, the clear ink droplets are applied uniformly, and then, without temporarily curing the ink droplets, the ink droplets are completely cured by the irradiating ultraviolet light using the full-curing unit 450. By this, the ink will remain fluid until just before it is completely cured, so the surface of the printed layer formed by the clear ink will be smooth. Gloss finish means a finish with enhanced gloss. Note that the method of curing the clear ink is not limited to the method described above.

The controller 460 controls each section of the printing device 400. The controller 460 is a computer with a memory, a processor, and the like.

As shown in FIG. 1, the image processing device 100 is a computer that has a memory 101, an input and output interface 102, a processor 103, and an internal bus 104. The memory 101, the input and output interface 102, and the processor 103 are communicatively connected via the internal bus 104. The memory 101 stores various programs and various data used for various processes executed by the image processing device 100. The programs PG are stored in memory 101. The input and output interface 102 is connected to the input device 200, the display device 300, and the printing device 400 via wired communication or wireless communication. The processor 103 realizes various functions by executing the programs stored in the memory 101. The input device 200 is, for example, a keyboard or a mouse. The display device 300 is, for example, a liquid crystal display or an organic electro luminescence (EL) display. In the present embodiment, the display device 300 also has a function as a pointing device.

The image processing device 100 generates a rendering image corresponding to the appearance of the printed matter in a three-dimensional virtual space using physical-based rendering (hereinafter, simply referred to as rendering). The image processing device 100 displays the generated rendering image as a preview image on the display device 300 before printing. In the present embodiment, the appearance of the printed matter in the three-dimensional virtual space is defined by a position and orientation of a three dimensional object in the virtual space, or a viewpoint position and line of sight direction of the user with respect to the three dimensional object in the virtual space. The image processing device 100 generates print data for reproducing the quality of the printed matter represented in the preview image.

In the present embodiment, the image processing device 100 displays the rendering image as the preview image. FIG. 3 is an explanatory diagram schematically showing a state of observing a surface of printed matter expressed as a 3-D object in a virtual space. Here, an example of the printed matter printed with surface printing on the front surface of the flat shaped print medium PM will be described. The printed matter is represented as a three dimensional object (3-D object) OBJ. The 3-D object OBJ has a polygon object POa for rendering related to the print medium PM and a polygon object POb for rendering related to the printed layer.

Two polygon objects POa and POb are arranged parallel to each other. The direction of the normal vector Np of the polygon object POa is directed to the front surface side of the 3-D object OBJ. The 3-D object OBJ is illuminated by a light source LS. In FIG. 3, the line of sight of camera CM is represented by a broken line arrow. In FIG. 3, for convenience, the distance between the two polygon objects POa and POb is drawn as being large, but in reality, in the virtual space, the distance between polygon object POa and POb is a very short distance to the extent that Z-fighting does not occur. In the virtual space, the thickness of the polygon object POa representing the print medium PM reflects the thickness of the print medium PM, and the thickness of the polygon object Pob representing the printed layer is substantially zero.

In FIG. 3, coordinate systems used for the rendering process are shown as follows: the local coordinate system Σm (also referred to as the model coordinate system), which is a three dimensional Cartesian coordinate system of the 3-D object OBJ; the world coordinate system Σg (also referred to as the global coordinate system), which is a three dimensional Cartesian coordinate system of the virtual space; and the view coordinate system Σc (also referred to as the camera coordinate system), which is a three dimensional Cartesian coordinate system of the camera CM arranged in the virtual space. In the rendering process, other coordinate systems are also used, such as a screen coordinate system, which is a coordinate system of the screen on which the scene viewed from the camera CM is projected, but this is omitted in FIG. 3.

As shown in FIG. 3, with respect to the state in which the line of sight direction of the camera CM is directed to the front surface side of the 3-D object OBJ, a front surface side view obtained by observing the surface side of the 3-D object OBJ through the camera CM is generated as the rendering image.

The polygon objects POa and Pob may be composed in one polygon. Also, each of the polygon objects POa and POb may be composed of a plurality of small polygons. If the polygon object is composed of multiple polygons, it is possible to easily generate not only a rendering image of flat printed matter but also a rendering image of curved printed matter.

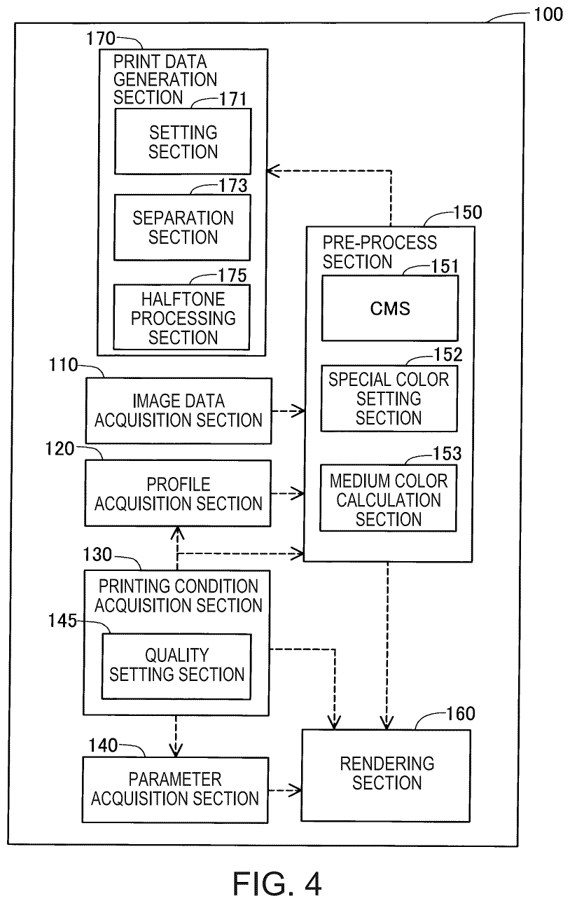

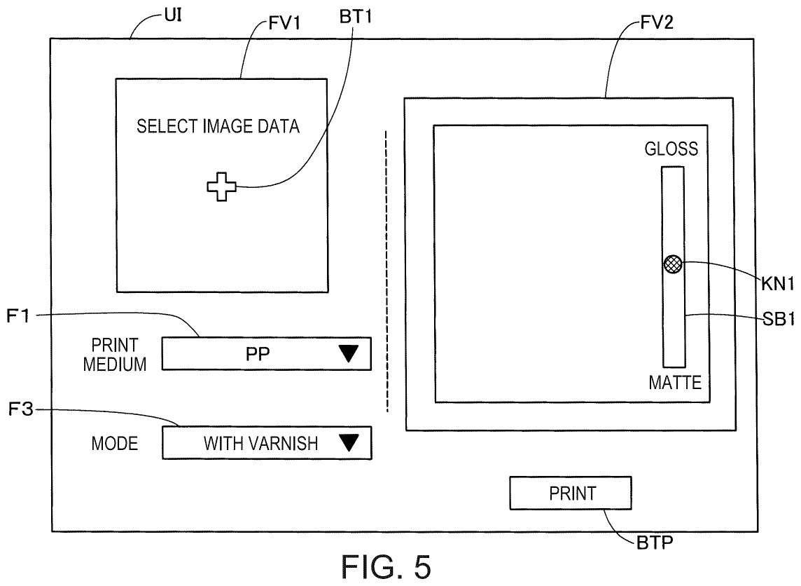

FIG. 4 is an explanatory diagram showing the configuration of the image processing device 100. The image processing device 100 is equipped with an image data acquisition section 110, a profile acquisition section 120, a printing condition acquisition section 130, a parameter acquisition section 140, a pre-process section 150, a rendering section 160, and a print data generation section 170. The functions of these sections are realized by the processor 103 executing the programs PG stored in memory 101 shown in FIG. 1. The rendering section 160 is also referred to as a “preview image display section.” The print data generation section 170 is also referred to as a “print process section.”

FIG. 5 is an explanatory diagram showing an example of a user interface UI for specifying printing conditions. The user interface UI is displayed on the display device 300 under the control of the processor 103. The user interface UI is provided with an input region F1 for inputting a type of the print medium, an input region F3 for inputting a print mode, a display region FV1 for displaying an image selected by the user, a display region FV2 for displaying a preview image, a button BT1 for selecting an image to be printed, and a print button BTP for instructing to start printing. The display region FV2 also displays a slider bar SB1. The slider bar SB1 is an example of an interface for adjusting the gloss. Details of the slider bar SB1 will be described later.

The user inputs the type of print medium in the input region F1. As the print medium, a transparent film or sheet formed of a material such as polypropylene (PP), polyethylene (PET), or polyvinyl chloride (PVC) can be used. The print medium may be transparent, semi-transparent, or opaque. In this embodiment, a process for using an opaque print medium will be described. Note that even when using a transparent print medium or a semi-transparent print medium, substantially the same process can be applied.

The user inputs a print mode in the input region F3. In the present embodiment, either “with varnish” or “without varnish” mode can be selected. “With varnish” is a mode in which printing with the clear ink is performed after printing with the process ink. In other words, it is a mode that forms the clear layer. “Without varnish” is a mode in which printing with the clear ink is not performed after printing with the process ink. In other words, it is a mode that does not form a clear layer. If “with varnish” is selected, it is possible to give the printed matter a glossy or matte finish. The gloss finish and the matte finish are achieved by adjusting gloss intensity. The term “gloss” refers to a state in which light is reflected uniformly due to the extremely smooth surface. In the printed matter that was given a gloss finish, vivid colors can be achieved. The term “matte” refers to a state in which almost no specular reflection light is reflected due to the surface not being smooth.

By tapping the button BT1, the user can select image data stored in advance in the memory 101 of the image processing device 100, for example. The image represented by the selected image data is displayed in FV1.

The image data acquisition section 110 shown in FIG. 4 acquires image data selected in the input region F1 of the user interface UI (see FIG. 5). The image data selected in the input region F1 is referred to as input image data IMi. The input image data IMi represents an image to be formed on the print medium. The input image data IMi is transmitted to the pre-process section 150. An image represented by the input image data IMi is also referred to as a target image.

The profile acquisition section 120 acquires an input profile IPF, a medium profile MPF, and a common color space profile CPF, which are stored in advance in the memory 101. Note that the input profile IPF, the medium profile MPF, and the common color space profile CPF are omitted in FIG. 1. The input profile IPF, the medium profile MPF, and the common color space profile CPF are used for color conversion by the color management system 151 of the pre-process section 150 (to be described later). Details of each profile will be described later. Each acquired profile is transmitted to the pre-process section 150. Note that the profile acquisition section 120 may acquire each profile from an external server via a network (not shown).

The printing condition acquisition section 130 acquires a printing condition. The printing condition includes conditions such as the type of print medium, the type of printing machine, the number of printed layers, the type of ink of each printing layer, and the resolution of printing. In the present embodiment, the printing condition acquisition section 130 acquires as the printing condition the type of the print medium selected in the input region F1 (see FIG. 5) of the user interface UI and the printing mode selected in the input region F3. The printing condition acquired by the printing condition acquisition section 130 is transmitted to the profile acquisition section 120, the pre-process section 150, and the parameter acquisition section 140.

The printing condition acquisition section 130 includes a quality setting section 145. The quality setting section 145 sets a quality parameter for determining the quality of the color image. In the present embodiment, the quality of the color image is defined by the gloss intensity, texture, and the like. The quality setting section 145 sets “smoothness” as the quality parameter. The quality parameter is transmitted to the pre-process section 150.

The parameter acquisition section 140 acquires various parameters used for rendering from the memory 101. The various parameters are stored in the memory 101 in advance. The various parameters used for rendering include, for example, three dimensional object information (hereinafter referred to as 3-D object information), camera information, lighting information, and medium parameters. The 3-D object information is a parameter relating to the shape of the print medium as a three dimensional object (hereafter referred to a “3-D object”) arranged in the virtual space. The camera information is a parameter relating to the position and direction of the camera arranged in the virtual space. The lighting information is a parameter relating to the type of light source arranged in the virtual space, the position and direction of the light source, the color, and the luminous intensity (amount of light). The type of light source includes, for example, a fluorescent lamp and an incandescent lamp.

The medium parameter is a parameter related to the quality of the print medium. In the present embodiment, the medium parameter includes a quality parameter indicating the quality of the print medium. The quality parameter includes, for example, a base color relating to the background color of the print medium, smoothness representing the smoothness of the print medium, a quality parameter of gloss realized by the clear ink, a normal map, and a height map. The quality parameter of gloss realized with the clear ink includes a table in which the gloss texture is defined. The gloss texture includes, for example, uniform gloss, a raster finish, and a silk finish. Each quality parameter may include roughness that represents the roughness of the print medium, instead of the smoothness. The normal map and the height map are used to represent the minute unevenness of the print medium that affects the reflection of light. The normal map is a texture representing distribution of normal vectors of the minute uneven surface. The height map is a texture representing distribution of the height of the minute uneven surface. If the size of polygons that constitute the 3-D object is reduced in order to express minute unevenness, the number of polygons will increase enormously, and the calculation load of rendering will increase. By using the normal map or the height map, it becomes possible to represent affects of light reflection from minute uneven surfaces without having to reduce the size of the polygons.

Various parameters acquired by the parameter acquisition section 140 are transmitted to the rendering section 160. The parameter acquisition section 140 may acquire the various parameters from an external server via a network (not shown).

The pre-process section 150 includes a color management system 151, a special color setting section 152, and a medium color calculation section 153. Hereinafter, the color management system 151 may be simply referred to as CMS 151.

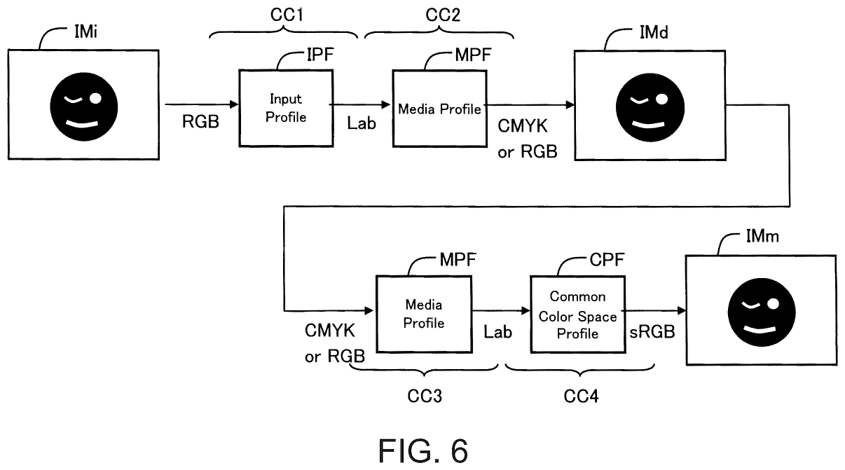

FIG. 6 is an explanatory diagram showing process contents of the CMS 151. The CMS 151 executes various color conversion processes using each profile acquired by the profile acquisition section 120.

The input profile IPF is an International Color Consortium (ICC) profile used for color conversion from a color space of the image data (an input color space) to a device-independent color space. The input color space is, for example, an RGB color space. The device-independent color space is, for example, the CIE-L*a*b* color space. The medium profile MPF is an ICC profile used for color conversion from a device-independent color space to a device-dependent color space of the printing device 400. The device-dependent color space of the printing device 400 is, for example, the CMYK color space. The color of the device-dependent color space of the printing device 400 is also referred to as device color. The common color space profile is an ICC profile used for color conversion from the device-independent color space to a rendering color space. The color space for rendering is, for example, sRGB, Adobe RGB, and Display-P3.

An example of the color conversion processing executed by the CMS 151 is as follows. The CMS 151 sequentially executes the following color conversion processes on the input image data IMi.

(1) A first color conversion CC1 from the input color space to the device-independent space using the input profile IPF.
(2) A second color conversion CC2 from the device-independent color space to the device-dependent color space of the printing device 400 using the medium profile MPF.
(3) A third color conversion CC3 from the device-dependent color space of the printing device 400 to the device-independent color space using the medium profile MPF.
(4) A fourth color conversion CC4 from the device-independent color space to the color space for rendering using the common color space profile CPF.

By the first color conversion CC1 and the second color conversion CC2, color value of the image data is converted into a range that can be represented by printing. In other words, the first color conversion CC 1 and the second color conversion CC 2 convert the color value of the image data into the color value of the color space that is dependent on the printing device and the print medium. The image data subjected to the first color conversion CC1 and the second color conversion CC2 is referred to as device color image data IMd. The device color image data IMd is transmitted to the print data generation section 170 (see FIG. 4).

As shown in FIG. 6, by the third color conversion CC3 and the fourth color conversion CC4, the color value of the image data is converted into a range that can be represented by rendering. By the first color conversion CC1 to the fourth color conversion CC4 being implemented, the color value of the image data is converted to the color value of the color space for rendering. The image data converted into the color value of the color space for rendering is referred to as image data for rendering IMm. The image data for rendering IMm is used as a texture added to a polygon representing a color layer in rendering. The RGBA value of the base color of the color layer is set to (1, 1, 1, 1). The image data for rendering IMm is transmitted to the rendering section 160.

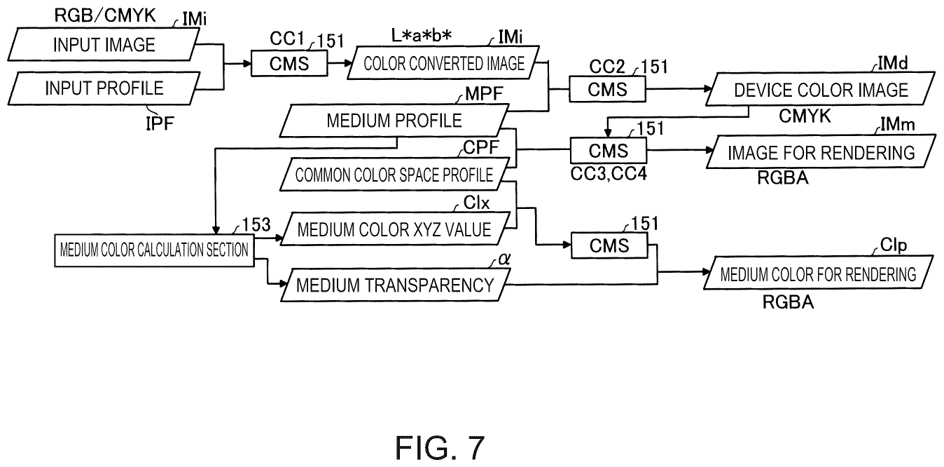

FIG. 7 is an explanatory diagram showing a flowchart of a color conversion process. In FIG. 7, for convenience of description, a plurality of CMS 151 are illustrated, but these are the same CMS 151.

The special color setting section 152 generates special color image data IMt. When the start of printing is instructed by pressing the print button BTP of the user interface UI, the special color image data IMt is generated. The special color image data IMt is image data for printing of the clear layer. Note that when the clear layer is not to be formed, it is unnecessary to generate the special color image data IMt. In the present embodiment, in order to facilitate understanding of the technique, it is assumed that the clear ink is printed on the same region as the region printed with process ink.

The special color setting section 152 generates special color image data IMt using the input image data IMi. The special color setting section 152 determines a region to be printed with the process ink from the input image data IMi, and generates the special color image data IMt. The special color image data IMt indicates a region where the clear ink is printed to form the clear layer. The special color image data IMt is used when the print data of the clear ink is created. Details of the generation of the special color image data IMt will be described later. The special color image data IMt is transmitted to the print data generation section 170.

The medium color calculation section 153 acquires an XYZ value representing the color of the print medium PM from the medium profile MPF. The XYZ value representing the color of the print medium PM is stored in the medium profile MPF in advance. The CMS 151 converts the XYZ value Clx representing the color of the print medium PM into an RGB value using the common color space profile CPF. The medium color calculation section 153 outputs, to the rendering section 160, the RGB value obtained by converting the XYZ value Clx, which represents the color of the print medium PM.

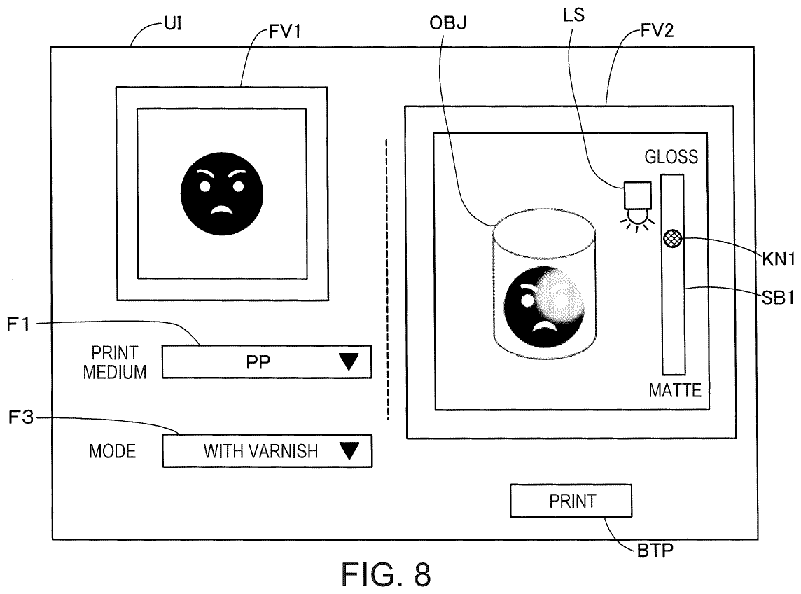

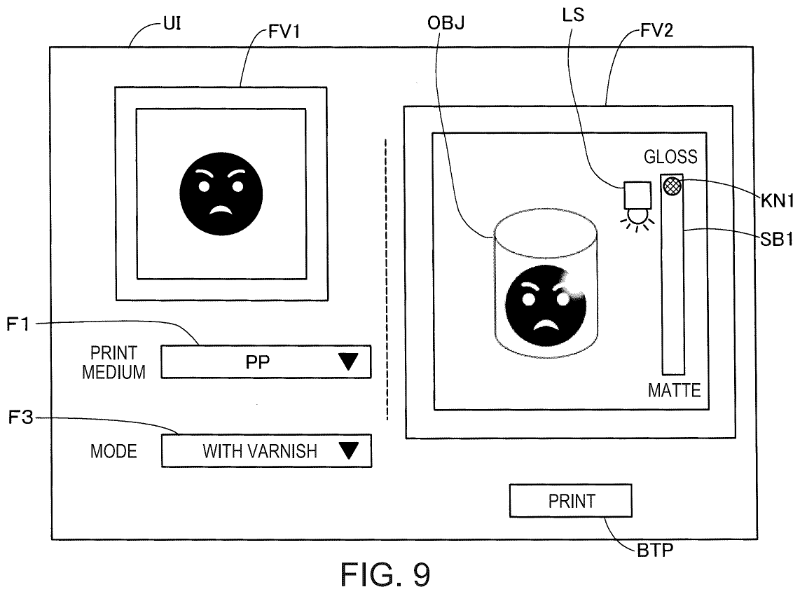

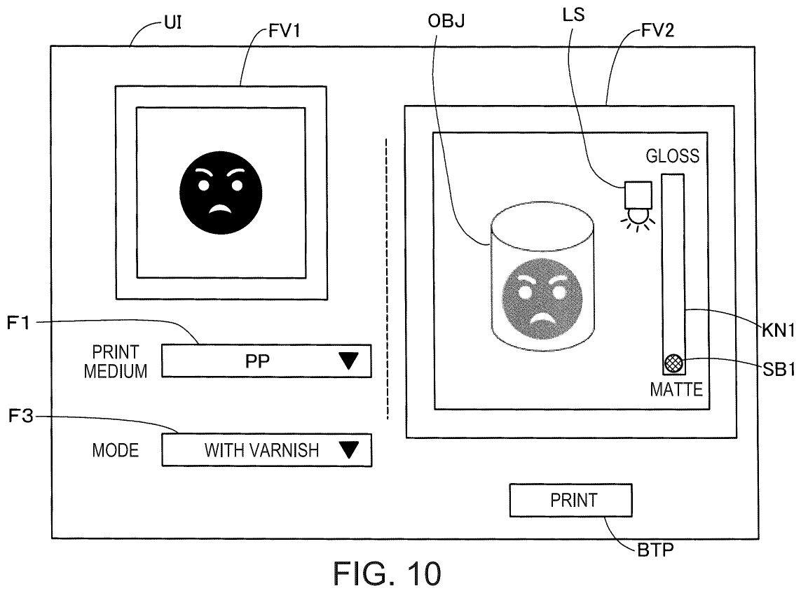

FIG. 8 is an explanatory diagram showing a state where the preview image is displayed in the display region FV2 of the user interface UI. In the display region FV2, the slider bar SB1 is displayed together with the 3-D object OBJ. The slider bar SB1 is used to adjust the gloss intensity. The user can instruct to increase the gloss intensity by moving the knob KN1 to the gloss side. The user can instruct to weaken the gloss intensity by moving the knob KN1 to the matte side. In response to an operation instruction of the knob KN1, the rendering section 160 executes the rendering process again and updates the display of the preview image. FIG. 9 is an explanatory view showing a state where the display of the preview image has been updated in the user interface UI after the setting is changed to the gloss side by the user moving the knob KN1 to the gloss side. FIG. 10 is an explanatory view showing a state where the display of the preview image has been updated in the user interface UI after the setting is changed to the matte side by the user moving the knob KN1 to the matte side. The quality setting section 145 sets the quality parameter in response to an operation instruction from the user. Details of the process of the quality setting section 145 will be described later.

The rendering section 160 generates a rendering image that represents how the print medium with the image is printed on it will look in the virtual space. In rendering, the printed matter is represented as a 3-D object in the virtual space.

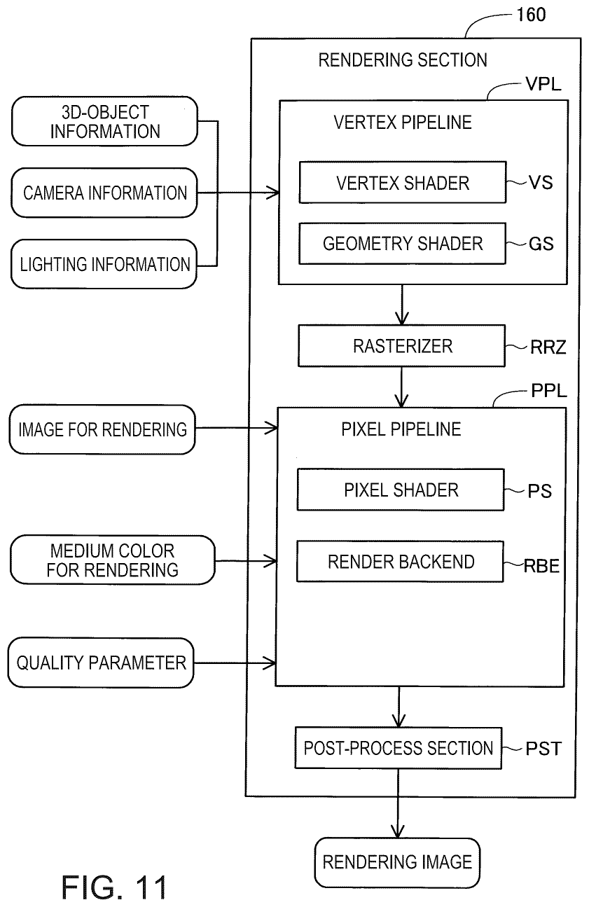

FIG. 11 is an explanatory diagram showing a configuration of the rendering section 160. The rendering section 160 employs a pipeline configuration including a vertex pipeline VPL, a rasterizer RRZ, a pixel pipeline PPL, and a post-process section. The vertex pipeline VPL has a vertex shader VS and a geometry shader GS. The pixel pipeline PPL has a pixel shader PS and a render backend RBE.

The vertex shader VS executes a process related to the polygons that constitute the 3-D object using the 3-D object information, the camera information, and the lighting information. This process includes coordinate conversion of the vertices of each polygon constituting the 3-D object, calculation of the normal vector of each polygon, shading process, calculation of texture mapping coordinates (UV coordinate), and the like. The coordinate conversion includes a model conversion, which is a coordinate conversion of the 3-D object from the local coordinate system to the world coordinate system, a view conversion, which is a coordinate conversion from the world coordinate system to the view coordinate system, and a projection conversion, which is a coordinate conversion from the view coordinate system to the screen coordinate system. Some of the coordinate conversions described above may be executed by the geometry shader GS. The processing result of the vertex shader VS is transmitted to the geometry shader GS.

The geometry shader GS processes a set of vertices of the 3-D object. The geometry shader GS, by increasing or decreasing the number of vertices, can convert polygons into points and lines and can convert points or lines into polygons. The processing result of the geometry shader GS is transmitted to the rasterizer RRZ. Note that the geometry shader GS may not be provided in the rendering section 160. In this case, the processing result of the vertex shader VS is transmitted to the rasterizer RRZ.

The rasterizer RRZ generates drawing information for each pixel from the processing result of the vertex pipeline VPL by executing the rasterization process. The processing result of the rasterizer RRZ is transmitted to the pixel shader PS.

The pixel shader PS calculates the color of the surface polygon corresponding to each pixel by executing the lighting process using the 3-D object subjected to the rasterization process, the image data, and the quality parameter set by the quality setting section 145. As a function for calculating the reflection of light in the lighting process, for example, the Disney principled Bidirectional Reflectance Distribution Function (BRDF) can be used. The processing result of the pixel shader PS is transmitted to the render backend RBE.

The render backend RBE determines whether or not to write pixel data generated by the pixel shader PS into a display region of the memory 101. If the render backend RBE determines to write to memory 101, the pixel data is saved as a drawing target, and if the render backend RBE does not determine to write to memory 101, the pixel data is not saved as a drawing target. An alpha test, a depth test, a stencil test, or the like is used to determine whether or not to write, for example. In the present embodiment, the pixel data includes information about the color of the surface polygon. The render backend RBE writes the color of the polygon object in order from the rear side with respect to the camera using a depth sort method, for example. When the render backend RBE writes the color of the polygon object on the front side after writing the color of the polygon object on the rear side, the render backend RBE synthesizes the color of the polygon on the rear side and the color of the polygon on the front side according to the transmittancy of the polygon on the front side using, for example, alpha blending. If the transmittancy is zero, when the color of the front side polygon is written, the color of rear side polygon will be overwritten with the color of front side polygon. Such a process of writing to display region is also referred to as a “drawing process.” When the pixel data is written to the memory 101, the pipeline processing will end.

The post-process section PST executes a post-process for the rendering image composed of the pixel data stored in the memory 101, such as anti-aliasing, ambient occlusion, screen space reflection, and depth of field processing. The post-process can improve the appearance of the rendering image.

The print data generation section 170 generates print data to be supplied to the printing device 400. The print data generation section 170 has a setting section 171, a separation section 173, and a halftone processing section 175.

The setting section 171 determines the order in which the printed layers are stacked. Specifically, if there are multiple printed layers, the stacking order of the multiple printed layers is determined according to the printing condition. If the printing mode is set to “with varnish” in the user interface UI, the number of printed layers will be two layers: the color layer and the clear layer. In this case, it is determined that the color layer is printed on the print medium first, and then the clear layer will be printed. If the printing mode is set to “without varnish”, the number of printed layers will be one layer, which is the color layer. Note that if the printing of the color layer and the printing of the clear layer are performed in the same process, the setting section 171 is not necessary.

The separation section 173 converts an output value of each pixel of the device color image data IMd into a density value of a plurality of color materials of the printing device 400. For example, in the present embodiment, the separation section 173, by referring to a look up table (LUT), converts the output value CMYK of each pixel of the device color image data IMd into the density value of each color of the process ink. Further, the separation section 173 converts the output value of each pixel of the special color image data IMt into the density value of the clear ink. The density value of the clear ink may be an initially set value or may be specified by the user. Through the process of the separation section 173, each of CMYKLcLm plates and special color plate are generated.

The halftone processing section 175 generates print data by executing a halftone processing using the density value of each pixel after the separation process. The printing device 400 receives the print data transmitted from the halftone processing section 175, and executes printing based on the printing condition included in the received print data.

FIG. 12 is a flowchart showing a process executed by the image processing device 100 before the printing is executed. For example, if the image processing device 100 receives an operation instruction of the user via the input device 200, the process of FIG. 12 starts.

In step S10, input image data IMi and printing condition are acquired. Specifically, first, the user interface UI (see FIG. 5) is displayed on the display device 300. The image data (input image data IMi) specified by user input via the user interface UI is acquired. Further, information indicating the printing condition input by the user via the user interface UI is acquired. In the example shown in FIG. 5, specifications of the type of the print medium, the print mode, and the quality are acquired as the printing condition. The process of step S10 is executed by the processor 103 that functions as the image data acquisition section 110 and the printing condition acquisition section 130.

The process of step S20 is executed by the color management system 151 and the medium color calculation section 153. The content of each process executed by the color management system 151 and the medium color calculation section 153 are as shown in FIG. 7. In the pre-processing, the device color image data IMd, the image data for rendering IMm, and a medium color for rendering Clp are generated. The device color image data IMd is transmitted to the print data generation section 170. The image data for rendering IMm and the medium color for rendering Clp are transmitted to the rendering section 160.

In step S30, the rendering image generated by the rendering section 160 is displayed as the preview image on the display device 300. Details of the process of step S30 will be described later. The process of the rendering section 160 is as shown in FIG. 11. The above is the process executed by the image processing device 100 before the printing is executed.

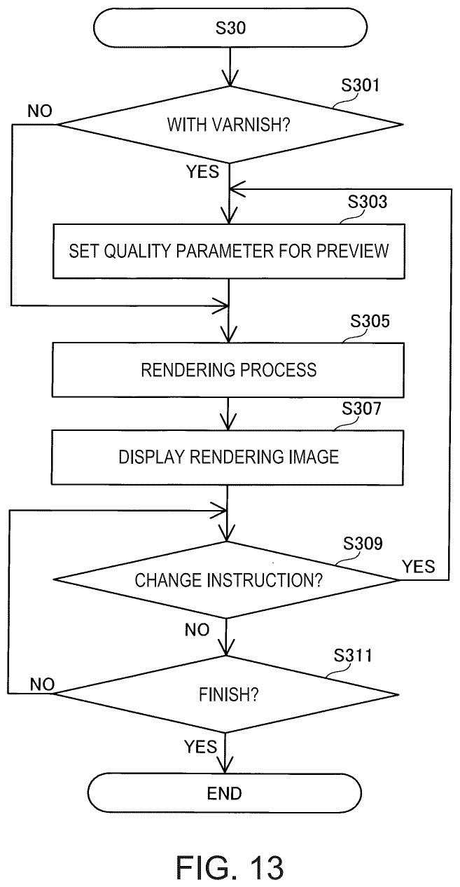

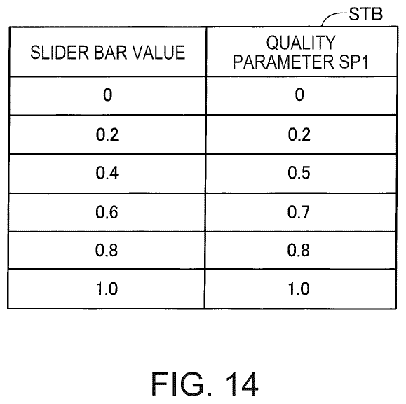

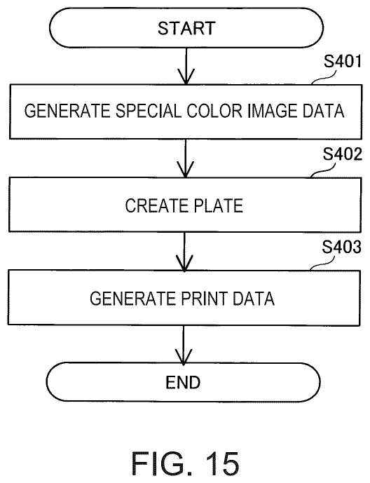

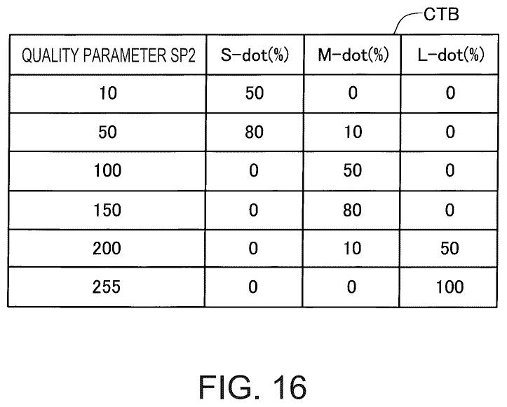

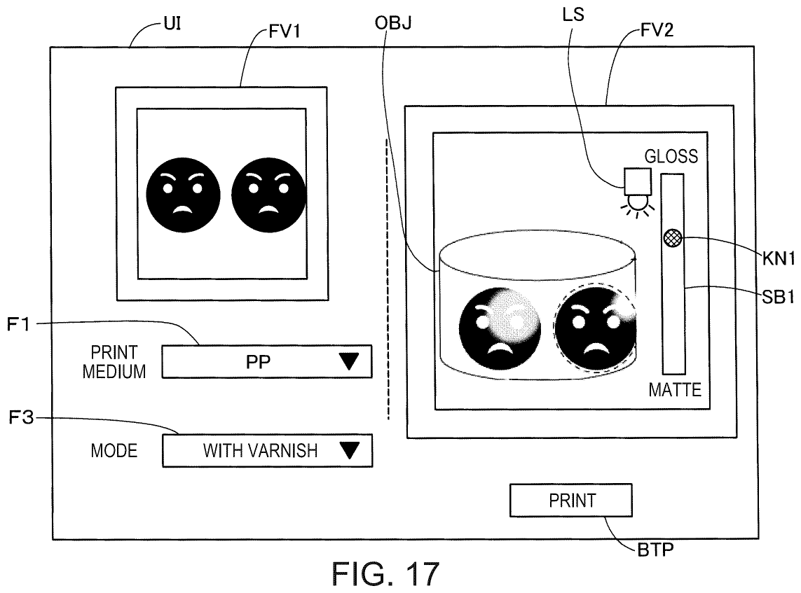

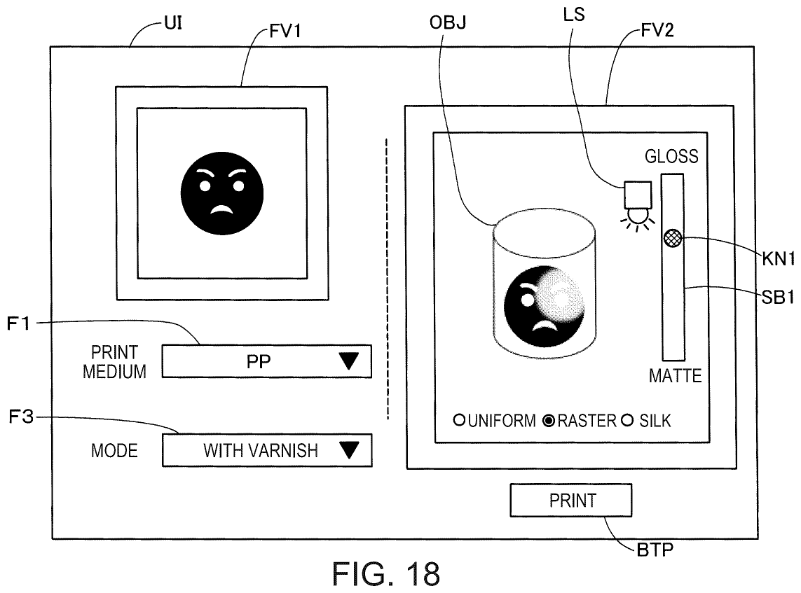

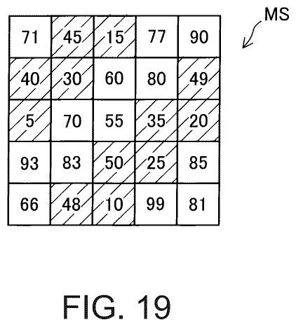

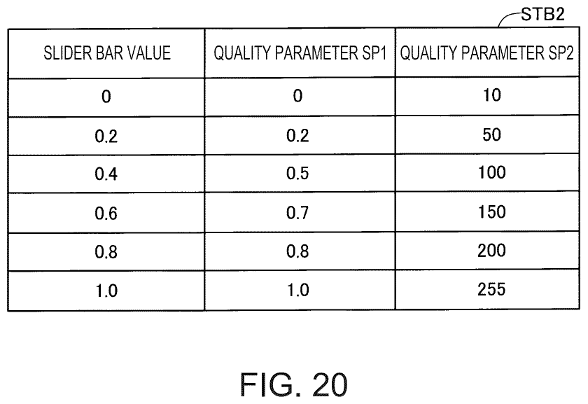

FIG. 13 is a flowchart of a process for displaying a preview image in step S30 in FIG. 12. In step S301, the quality setting section 145 determines whether or not the type of printing is specified as “with varnish” in the user interface UI. If the printing mode is specified as “with varnish” (step S301; YES), the process of step S303 is executed. In the present embodiment, to facilitate understanding of the technique, it is assumed that when the printing mode is specified as “with varnish”, the clear ink is printed in the same region as the region printed with the process ink. If the printing mode is specified as “without varnish” (step S301; NO), the process of step S305 is executed.

In step S303, the quality setting section 145 sets a quality parameter for preview.

During a first execution of step S303, a quality parameter SP1 for preview corresponding to the print medium selected in the user interface UI is read out from the memory 101. In the present embodiment, the quality parameter represents the gloss intensity. The initial value of the quality parameter SP1 for preview for each type of print medium is stored in the memory 101 in advance. The first execution of step S303 means step S303 that is executed for the first time during the period from the start to the end of the process shown in FIG. 13.

Based on the quality parameter SP1 corresponding to the type of print medium, an initial position of the knob KN1 of the slider bar SB1 in the user interface UI is determined (see FIG. 8). The quality parameter SP1 for preview is assumed to have a value in the range of 0 to 1. For example, it is assumed that the quality parameter SP1 is 0.8. In this case, it is determined that the knob KN1 is arranged at a position corresponding to 0.8 on the slider bar SB1. The quality parameter SP1 for rendering is transmitted to the rendering section 160. The quality parameter SP1 for rendering transmitted to the rendering section 160 is used as smoothness, which is one of the quality parameters. A quality parameter SP2 for printing is determined based on the quality parameter SP1 for preview using the following equation (1). The quality parameter SP2 for printing is stored in memory. The quality parameter SP2 for printing is used when the special color image data IMt, which is image data for printing the clear layer, is generated. The quality parameter SP2 for printing takes a value in the range of 0 to 255.

quality parameter SP2 for printing=quality parameter SP1 for preview×255 (1)

In the second and subsequent executions of step S303, the quality parameter SP1 for preview and the quality parameter SP2 for printing are determined based on the position of the knob KN1 of the slider bar SB1. The position of the knob KN1 on the slider bar SB1 represents a specified value for specifying the degree of the quality.

FIG. 14 is an explanatory diagram showing a quality parameter conversion table STB. The quality parameter conversion table STB is stored in the memory 101 in advance. Note that the quality parameter conversion table STB is not illustrated in FIG. 1. In the quality parameter conversion table STB, the correspondence between the position of the knob KN1 and the quality parameter SP1 for preview is defined. When the position of the knob KN1 is located at 1.0, as shown in FIG. 9, it indicates that the knob KN1 is located at the most gloss side of the slider bar SB1. When the position of the knob KN1 is located at 0, as shown in FIG. 10, it indicates that the knob KN1 is located farthest to the matte side of the slider bar SB1. Based on the position of the knob KN1 of the slider bar SB1, the quality parameter SP1 for preview is acquired from the quality parameter conversion table STB. Note that the quality parameter SP1 corresponding to the slider bar value that is not defined in the quality parameter conversion table STB is determined by an interpolation process using a nearby defined value. By using equation (1) described above, the quality parameter SP2 for printing is determined based on the quality parameter SP1 for preview.

In step S305 shown in FIG. 13, the rendering section 160 executes the rendering process. If the printing mode is specified as “with varnish” in the user interface UI, the quality parameter SP1 determined in step S303 is used in the rendering process. In step 307, the rendering image is displayed in the display region FV2 of the user interface UI.

In step S309, the quality setting section 145 determines whether or not a change instruction is received, that is, whether or not the knob KN1 is moved in the user interface UI. If the change instruction is received (step S309; YES), the process of step S303 is executed again. If a change instruction was not received (step S309; NO), the process of step S311 is executed. In step S311, it is determined whether or not the process is to be terminated. If the print button BTP is pressed in the user interface UI, it is determined that the process shown in FIG. 13 will end. The fact that the print button BTP was pressed indicates that the start of printing has been accepted. If the process is not to be terminated (step S311; NO), the process of step S309 is executed again. If the process is to be terminated (step S311; YES), the process shown in FIG. 13 will end.

FIG. 15 is a flowchart of a process for generating print data. As described above, if the print button BTP is pressed in step S30 of FIG. 12, the process of FIG. 12 will end (see step S311 of FIG. 13). The processing of FIG. 15 is executed after the process of FIG. 12 is executed.

In step S401, the special color setting section 152 generates special color image data IMt, which is image data for printing of the clear layer. Note that when the clear layer is not to be formed, it is unnecessary to generate the special color image data IMt.

In a case where the clear ink is printed in the same region as the region printed with the process ink, the special color setting section 152 determines the region occupied by the image to be printed with the process ink from the value of each pixel of the input image data IMi. The region occupied by the image to be printed means the region composed of pixels that have a substantial color, that is, pixels that are not R=G=B=1. The special color setting section 152 generates the special color image data IMt by setting the quality parameter SP2 to the pixels corresponding to the region printed by the process ink. The quality parameter SP2 is set together with the quality parameter SP1 for preview described above (see step S303 in FIG. 13).

When the clear ink is printed on the entire region, the special color setting section 152 determines the region in which the process ink is printed based on the image size of the input image data IMi. The special color setting section 152 generates the special color image data IMt by setting the quality parameter SP2 to the pixels corresponding to the region printed by the process ink.

In step S402, the separation section 173 creates each plate of CMYKLcLm and a clear plate if necessary. Each plate of the CMYKLcLm is created based on the device color image data IMd. The clear plate is created based on the special color image data IMt.

FIG. 16 is an explanatory diagram showing the clear ink printing conversion table CTB. The clear ink printing conversion table CTB is stored in the memory 101 in advance. The clear ink printing conversion table CTB is not shown in FIG. 1. In the clear ink printing conversion table CTB, the correspondence between the quality parameter SP2 for printing and a recording amount of ink (the number of recorded ink droplets) that is for each dot size of ink (the size of the ink droplet) and that is used in the printing of the clear layer is defined. For example, the dot sizes S, M, and L are 2.5 picoliter, 9 picoliter, and 18 picoliter, respectively. The quality parameter SP2 for printing has been determined in the display process for the preview image (see step S303 in FIG. 13). The recording amount of ink for each dot size is determined based on the quality parameter SP2 for printing using the clear ink printing conversion table CTB. Note that the quality parameter SP2 that is not defined in the quality parameter conversion table STB is determined by an interpolation process using a nearby defined value.

For example, if the quality parameter SP2 for printing is 100, the recording amount of M size dots is 50%. In this case, in the halftone process, in the dither mask where the maximum value is defined as 100 percent, dots are recorded for pixels with a value of 50 or less, where the maximum value is set to 100 percent.

In step S403 shown in FIG. 15, the halftone processing section 175 executes halftone processing on each plate created in step S402. The halftone processing section 175 executes a process of assigning each dot and the nozzle that ejects the dot using the halftone-processed data, and generates print data. The generated print data includes color ink information related to the printing of the process ink and clear ink information related to the printing of the clear ink. When the generated print data is transmitted to the printing device 400, the printing device 400 executes printing.

As described above, in the present embodiment, the user can grasp the finished state of the printed matter in which the desired degree of the quality is reproduced. If the change instruction to adjust the degree of the quality is received, the preview image display will be updated. In addition, the user can confirm the finished state by the preview image, so the user can make sufficient adjustments before printing so that the printed matter will be the desired degree of the quality.

### B. Other Embodiments

### B1. Other Embodiment 1

FIG. 17 is an explanatory diagram of a user interface UI according to another embodiment 1. In the above-described embodiment, an example of reproducing the same quality throughout the same region as the region printed with process ink is explained. However, it is also possible to divide the image into multiple regions and to receive specifications for the degree of the quality for each small region.

By operating the slider bar SB1 of the user interface UI, the user can specify the gloss intensity for each small region. The quality setting section 145 sets the quality parameter SP1 for preview for each small region. As shown in FIG. 17, for each small region, by setting the quality parameter SP1 for preview in the pixel corresponding to the small regions, a smoothness map is generated. The quality parameter SP1 for the preview set for each small region will be a value specified by the user. In this case, the preview image that is displayed will reproduce a different quality for each region.

In addition, the special color setting section 152 generates the special color image data IMt based on the smoothness map. In this way, it is possible to obtain print data that reproduces the quality of the printed matter represented by the preview image. Therefore, it is possible to flexibly respond to the user's request.

### B2. Other Embodiment 2

In above-described embodiment, an example where the quality of a color image is represented by the degree of gloss intensity is explained. In addition to the degree of gloss intensity, the quality of the color image may also be represented by the gloss texture. Gloss texture includes raster texture and silk texture. Raster texture is a texture in which the surface is covered with a pattern of fine dots or extremely short straight lines, and in which a glossy appearance is generated by light being reflected by the pattern. Silk texture is a texture that has a smooth surface and that uniformly reflects light. The glossiness of the silk texture is weaker than the glossiness of the gloss texture.

FIG. 18 is an explanatory diagram showing an example of a user interface UI in the present embodiment. In the user interface UI, the user can choose any one of options for the gloss texture: uniform gloss finish, raster finish, and silk finish. In this case, a quality parameter conversion table STB corresponding to each of the uniform gloss finish, the raster finish, and the silk finish is prepared in advance.

FIG. 19 is an explanatory diagram showing an example of a mask used in the halftone processing to realize the gloss texture. The mask MS shown in the figure is a mask used in the halftone processing when the raster finish is selected. In a case where the quality parameter SP2 is set to 100, it is determined based on the FIG. 16 that 50% of the ink droplets with dot size M are used. In this case, in the mask MS shown in FIG. 19, it is determined that ink droplets with dot size M will be recorded on the dots with values of 50 or less that are shaded.

### B3. Other Embodiment 3

In the above-described embodiment, it was explained an aspect of specifying the degree of the quality using the slider that can be operated by touch operation, but the aspect of specifying the degree of the quality is not limited to this. For example, the user may directly input a numerical value (input value) for specifying the degree of the quality in the user interface UI.

### B4. Other Embodiment 4

In the above-described embodiment, an example of calculating the quality parameter SP2 using equation (1) is explained. In the quality parameter conversion table STB, the quality parameter SP2 associated with the slider bar value may be defined. FIG. 20 is an explanatory diagram showing a quality parameter conversion table STB2. The quality parameter conversion table STB2 is stored in the memory 101 in advance. In the quality parameter conversion table STB shown in FIG. 15, the correspondence between the position of the knob KN1 and the quality parameter SP1 for preview is defined. In the quality parameter conversion table STB2 shown in FIG. 20, the correspondence between the position of the knob KN1, the quality parameter SP1 for preview, and the quality parameter SP2 for printing is defined. It is the same as the quality parameter conversion table STB shown in FIG. 15, except that the quality parameter SP2 for printing corresponding to the position of the knob KN1 is defined.

### B5. Other Embodiment 5

The print data may include information representing the irradiation intensity, the number of irradiations, and the irradiation time of the ultraviolet light to be irradiated after printing with the clear ink. These pieces of information may be determined according to the quality parameter SP2.

### C. Other Aspects

The present disclosure is not limited to the above-described embodiments, and can be realized by various configurations without departing from the scope of the present disclosure. For example, the technical features in the embodiments corresponding to the technical features in the embodiments described in the summary of the disclosure can be replaced or combined as appropriate in order to solve some or all of the problems described above or in order to achieve some or all of the effects described above. If the technical features are not described as essential in this specification, the technical features can be appropriately omitted.

(1) According to a first aspect of the present disclosure, an image processing method is provided. This image processing method includes a step (a) of displaying on a display device a preview image of printed matter that reproduces a degree of a quality represented by a specified value that was set, a step (b) of, when a change instruction to change the degree of the quality is received, executing step (a) by using the specified value based on the change instruction, a step (c) of generating print data for reproducing the quality of the printed matter represented by the preview image, the print data including color ink information that is defined for printing a target image and that represents, in a predetermined fixed region, at least one of the size of dots, the number of the dots, and an arrangement of dots to be recorded with color ink and clear ink information that is defined based on the specified value and that represents, in a predetermined fixed region, at least one of the size of dots, the number of the dots, and an arrangement of the dots to be recorded with clear ink, and a step (d) of printing the target image on a print medium with the color ink and then printing on the print medium on which the target image is printed with the clear ink based on the clear ink information.

According to the above aspect, the user can grasp the finished state of the printed matter in which the desired degree of the quality is reproduced. If the change instruction to adjust the degree of the quality is received, the preview image display will be updated. In addition, the user can confirm the finished state by the preview image, so the user can make sufficient adjustments before printing so that the printed matter will be the desired degree of the quality.

(2) In the image processing method according to the above aspect, in step (a), a user interface for receiving the change instruction may be displayed on the display device together with the preview image and in step (b), when the change instruction is received from the user via the user interface, by using a table or a function that defines the degree of the quality represented by the input value indicated by the change instruction, the specified value after the change may be determined based on the input value indicated by the change instruction.

According to the above aspect, the user can change the desired degree of the quality by an intuitive operation.

(3) The image processing method of the above aspects may further include a step (f) of receiving the specified value representing the degree of the quality for each of small regions obtained by dividing the target image into a plurality of regions and a step (g) of executing step (a) in accordance with the specified value for each of the small regions.

(4) The image processing method of the above aspects may be such that the clear ink is an ultraviolet curable type ink and in step (c), the print data includes information indicating irradiation intensity, the number of irradiations, irradiation time, and the timing of irradiation of the ultraviolet light to be irradiated after printing with the clear ink.

(5) According to a second aspect of the present disclosure, an image processing device is provided. This image processing device includes a preview image display section for displaying on a display device a preview image of printed matter in which degree of the quality represented by the specified value is reproduced; a quality setting section configured to receive a change instruction to change the degree of the quality; and a print process section that generates print data to be output to a printing device. When the change instruction to change the degree of the quality is received, the preview image display section displays the preview image on the display device using the specified value based on the change instruction. When a print start instruction is received, the print process section generates print data for reproducing the quality of the printed matter represented by the preview image, the print data including color ink information that is defined for printing a target image and that represents, in a predetermined fixed region, at least one of the size of dots, the number of the dots, and an arrangement of dots to be recorded with color ink and clear ink information that is defined based on the specified value and that represents, in a predetermined fixed region, at least one of the size of dots, the number of the dots, and an arrangement of the dots to be recorded with clear ink.

According to the above aspects, the user can grasp the finished state of the printed matter in which the desired degree of the quality is reproduced. If the change instruction to adjust the degree of the quality is received, the preview image display will be updated. In addition, the user can confirm the finished state by the preview image, so the user can make sufficient adjustments before printing so that the printed matter will be the desired degree of the quality.

(6) According to a third aspect of the present disclosure, a printing system is provided. This printing system includes an image processing device, a printing device, and a display device, the image processing device has a preview image display section that displays a preview image of printed matter that reproduces degree of a quality represented by a specified value that is set on the display device, a quality setting section configured to receive a change instruction to change the degree of the quality; and a print process section that generates print data to be output to the printing device. When the change instruction to change the degree of the quality is received, the preview image display section displays the preview image on the display device using the specified value based on the change instruction. When a print start instruction is received, the print process section generates print data for reproducing the quality of the printed matter represented by the preview image, the print data including color ink information that is defined for printing a target image and that represents, in a predetermined fixed region, at least one of the size of dots, the number of the dots, and an arrangement of dots to be recorded with color ink and clear ink information that is defined based on the specified value and that represents, in a predetermined fixed region, at least one of the size of dots, the number of the dots, and an arrangement of the dots to be recorded with clear ink. The printing device executes printing based on the print data.

According to the above aspects, the user can grasp the finished state of the printed matter in which the desired degree of the quality is reproduced. If the change instruction to adjust the degree of the quality is received, the preview image display will be updated. In addition, the user can confirm the finished state by the preview image, so the user can make sufficient adjustments before printing so that the printed matter will be the desired degree of the quality.

(7) According to a fourth aspect of the present disclosure, a non-transitory computer readable medium storing an image processing program is provided. This image processing program makes a computer execute a function (a) of displaying a preview image of printed matter that reproduces degree of a quality represented by a specified value that is set on a display device; a function (b) of, when a change instruction that changes the degree of the quality is received, executing the function (a) using the specified value based on the change instruction; a function (c) of generating print data for reproducing the quality of the printed matter represented by the preview image, the print data including color ink information that is defined for printing a target image and that represents, in a predetermined fixed region, at least one of the size of dots, the number of the dots, and an arrangement of dots to be recorded with color ink and clear ink information that is defined based on the specified value and that represents, in a predetermined fixed region, at least one of the size of dots, the number of the dots, and an arrangement of the dots to be recorded with clear ink, and a function (d) of printing the target image on a print medium with color ink, and then printing on the print medium on which the target image is printed with clear ink based on the clear ink information.

According to the above aspects, the user can grasp the finished state of the printed matter in which the desired degree of the quality is reproduced. If the change instruction to adjust the degree of the quality is received, the preview image display will be updated. In addition, the user can confirm the finished state by the preview image, so the user can make sufficient adjustments before printing so that the printed matter will be the desired degree of the quality.

What is claimed is:

1. An image processing method comprising:
a step (a) of displaying on a display device a preview image of printed matter that reproduces a degree of a quality represented by a specified value that was set;
a step (b) of, when a change instruction to change the degree of the quality is received, executing step (a) by using the specified value based on the change instruction;
a step (c) of generating print data for reproducing the quality of the printed matter represented by the preview image, the print data including
color ink information that is defined for printing a target image and that represents, in a predetermined fixed region, at least one of the size of dots, the number of the dots, and an arrangement of dots to be recorded with color ink and
clear ink information that is defined based on the specified value and that represents, in a predetermined fixed region, at least one of the size of dots, the number of the dots, and an arrangement of the dots to be recorded with clear ink; and
a step (d) of printing the target image on a print medium with the color ink and then printing on the print medium on which the target image is printed with the clear ink based on the clear ink information.

2. The image processing method according to claim 1, wherein
in step (a), a user interface for receiving the change instruction is displayed on the display device together with the preview image and
in step (b), when the change instruction is received from the user via the user interface, by using a table or a function that defines the degree of the quality represented by an input value indicated by the change instruction, the specified value after the change is determined based on the input value indicated by the change instruction.

3. The image processing method according to claim 2, further comprising:
a step (f) of receiving the specified value representing the degree of the quality for each of small regions obtained by dividing the target image into a plurality of regions and
a step (g) of executing step (a) in accordance with the specified value for each of the small regions.

4. The image processing method according to claim 3, wherein
the clear ink is an ultraviolet curable type ink and
in step (c), the print data includes information indicating irradiation intensity, the number of irradiations, irradiation time, and the timing of irradiation of the ultraviolet light to be irradiated after printing with the clear ink.

5. An image processing device comprising:
a preview image display section for displaying on a display device a preview image of printed matter in which degree of the quality represented by the specified value is reproduced;
a quality setting section configured to receive a change instruction to change the degree of the quality; and
a print process section that generates print data to be output to a printing device, wherein
when the change instruction to change the degree of the quality is received,
the preview image display section displays the preview image on the display device using the specified value based on the change instruction, when a print start instruction is received,
the print process section generates print data for reproducing the quality of the printed matter represented by the preview image, the print data including
color ink information that is defined for printing a target image and that represents, in a predetermined fixed region, at least one of the size of dots, the number of the dots, and an arrangement of dots to be recorded with color ink and
clear ink information that is defined based on the specified value and that represents, in a predetermined fixed region, at least one of the size of dots, the number of the dots, and an arrangement of the dots to be recorded with clear ink.

6. A printing system comprising:
an image processing device; a printing device; and a display device, wherein
the image processing device has
a preview image display section that displays a preview image of printed matter that reproduces degree of a quality represented by a specified value that is set on the display device,
a quality setting section configured to receive a change instruction to change the degree of the quality, and
a print process section that generates print data to be output to the printing device,
when the change instruction to change the degree of the quality is received, the preview image display section displays the preview image on the display device using the specified value based on the change instruction,
when a print start instruction is received,
the print process section generates print data for reproducing the quality of the printed matter represented by the preview image, the print data including
color ink information that is defined for printing a target image and that represents, in a predetermined fixed region, at least one of the size of dots, the number of the dots, and an arrangement of dots to be recorded with color ink and
clear ink information that is defined based on the specified value and that represents, in a predetermined fixed region, at least one of the size of dots, the number of the dots, and an arrangement of the dots to be recorded with clear ink, and
the printing device executes printing based on the print data.

7. A non-transitory computer readable medium storing an image processing program to be executed by a computer, the image processing program comprising:
a function (a) of displaying a preview image of printed matter that reproduces degree of a quality represented by a specified value that is set on a display device;
a function (b) of, when a change instruction that changes the degree of the quality is received, executing the function (a) using the specified value based on the change instruction;
a function (c) of generating print data for reproducing the quality of the printed matter represented by the preview image, the print data including
color ink information that is defined for printing a target image and that represents, in a predetermined fixed region, at least one of the size of dots, the number of the dots, and an arrangement of dots to be recorded with color ink and
clear ink information that is defined based on the specified value and that represents, in a predetermined fixed region, at least one of the size of dots, the number of the dots, and an arrangement of the dots to be recorded with clear ink; and
a function (d) of printing the target image on a print medium with color ink, and then printing on the print medium on which the target image is printed with clear ink based on the clear ink information.
